(19) United States
(12) Patent Application Publication
(10) Pub. No.: US 2009/0004500 A1
(43) Pub. Date: Jan. 1, 2009

(54) MULTILAYER PREFORM FOR FAST TRANSIENT LIQUID PHASE BONDING

(76) Inventors: Daewoong Suh, Phoenix, AZ (US); Jessica Weninger, Chandler, AZ (US)

Correspondence Address: INTEL CORPORATION;c/o INTELLEVATE, LLC, P.O. BOX 52050, MINNEAPOLIS, MN, 55402, US

(21) Appl. No.: 11/768,575

(22) Filed: Jun. 26, 2007

(51) Int. Cl. B32B 15/01; B23K 35/02; B32B 37/02

(52) U.S. Cl. 428/576; 29/469

(57) ABSTRACT

In some embodiments, a multilayer preform for fast transient liquid phase bonding is presented. In this regard, a method is introduced consisting of forming a plurality of first alloy layers, forming a plurality of second alloy layers, wherein the second alloy has a melting temperature that is higher than the melting temperature of the first alloy, and placing the first and second alloy layers together in an alternating sequence such that there is one more layer of the first alloy than of the second alloy and that the top and bottom layers of the formation are of the first alloy. Other embodiments are also disclosed and claimed.

### BACK GROUND OF THE INVENTION

Transient liquid phase (TLP) bonding has been used as a thermal interface material (TIM) to bond, for example, an integrated circuit die with an integrated heat spreader (IHS). TLP bonding involves Low Tm interlayer material sandwiched between two base metals. The low Tm interlayer has so-called Melting Point Depressant (MPD) which leads to a lower Tm than the base metal. At bonding temperature above Tm of the interlayer, the interlayer melts and the base metals do not. After dissolution of base metal into the molten interlayer, the solid (base metal) and the liquid (molten interlayer) equilibrium is reached. Due to interdiffusion of MPD into the base metal, the liquid becomes diminished (this is because MPD is being depleted from the liquid but due to thermodynamic equilibrium between the base metal and the interlayer, liquid concentration is maintained) and eventually all MPD is diffused to the base metal and isothermal solidification is achieved. Depending on original composition and bonding temperature/time, Tm of the final composition is typically higher than original Tm of interlayer, leading to higher remelting temperature. The time needed to reach equilibrium, however, can be prohibitively high.

### BRIEF DESCRIPTION OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIG. 1 represents a multilayer preform for fast transient liquid phase bonding according to an embodiment of the present invention.

FIG. 2 represents transient liquid phase bonding with a multilayer preform according to an embodiment of the present invention.

FIG. 3 represents an application of a multilayer preform for fast transient liquid phase bonding according to an embodiment of the present invention.

### DETAILED DESCRIPTION OF THE PRESENT INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein, in connection with one embodiment, may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

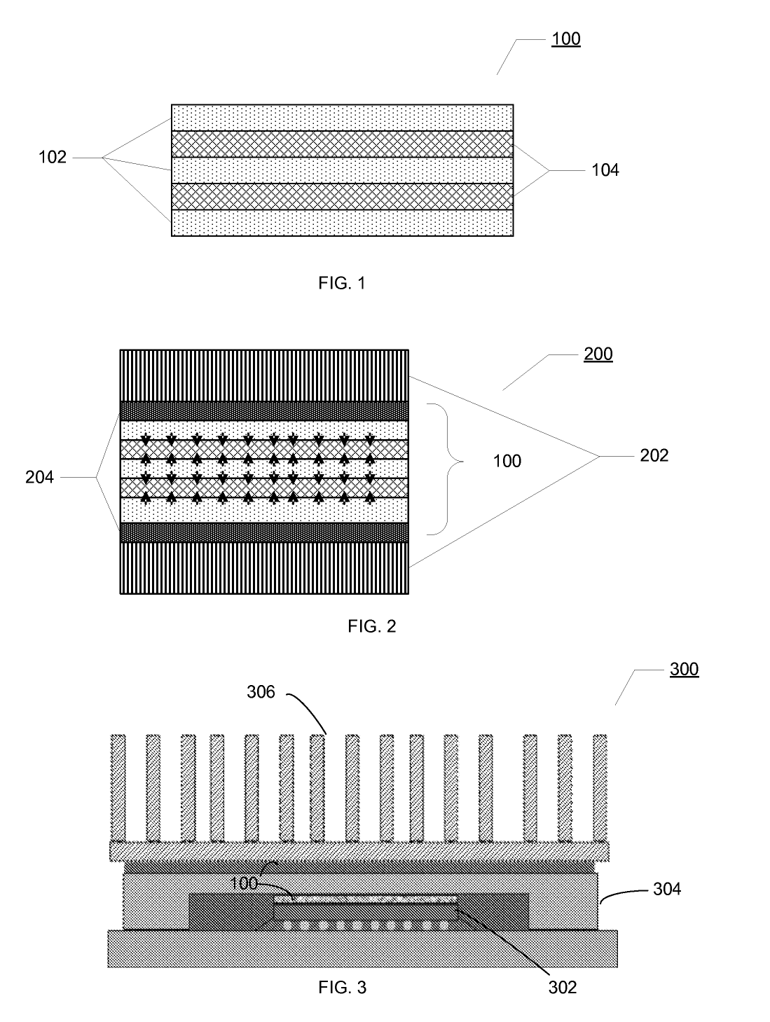

FIG. 1 represents a multilayer preform for fast transient liquid phase bonding according to an embodiment of the present invention. As shown, preform 100 contains three interlayer material layers 102 and two base metal layers 104 in an alternating sequence, though the present invention is not so limited. In one embodiment, preform 100 contains three base metal layers 104 and four interlayer material layers 102. In one embodiment, layers 102 and 104 are cold rolled and then pressure laminated together.

Interlayer material layers 102 represent metal alloys with a lower melting temperature than base metal layers 104. In one embodiment, interlayer material layers 102 include tin, indium, bismuth, silver, zinc, antimony, or combinations thereof. Some examples of possible interlayer material layers 102 with melting point depressant (MPD) include, but are not limited to: tin-52% indium, tin-57% bismuth, and tin-8.8% zinc.

Base metal layers 104 represent metal with a higher melting temperature than interlayer material layers 102. In one embodiment, base metal layers 104 comprise pure tin. In another embodiment, base metal layers 104 comprise a tin alloy with a similar composition as interlayer material layers 102, but with a higher tin content. For example, if interlayer material layers 102 were tin-52% indium, in one embodiment, base metal layers 104 could be tin-10% indium.

FIG. 2 represents transient liquid phase bonding with a multilayer preform according to an embodiment of the present invention. As shown, preform 100 has been placed between pads 202 as part of a transient liquid phase bonding. In one embodiment, pads 202 represent copper or nickel surfaces to be bonded. Pads 202 may be surfaces of a silicon device, heat spreader, heat sink, or other surface to be bonded.

In one embodiment, after the interlayer material layers 102 and the base metal layers 104 have been assembled together (by various methods such as sheet rolling and pre-form utilization) the preform 100 may undergo subsequent temperature processing, such as during a bonding process. In one embodiment, the temperature of such a process is higher than the melting temperature of the interlayer material layers 102 but lower than the melting temperature of the base metal layers 104 and may comprise between about 140 to about 160 degrees Celsius, but may vary depending upon the particular application.

During such a subsequent temperature process, the interlayer material layers 102 may interdiffuse into the base metal layers 104. The diffusion of MPD from the interlayer material layers 102 (shown by arrows) may result in little to no intermetallic formation between the base metal layers 104 and the interlayer material layers 102. However, intermetallic compound (IMC) 204 is formed at the interface of preform 100 and pads 202 and this IMC 204 blocks interdiffusion of MPD into pads 202. After temperature processing, isothermal solidification may be achieved and the preform 100 may comprise a homogenized TIM alloy, which may comprise a higher melting temperature than before such temperature processing, due to phase changes that may occur within the preform 100. A higher melting temperature of the preform 100 after a bonding process may serve to improve reliability of the TIM, and of a microelectronic structure utilizing the TIM.

By utilizing preform 100 with multiple base metal layers 104 and interlayer material layers 102, transient liquid phase bonding may be greater expedited. One skilled in the art would recognize that fast transient liquid phase bonding has the potential to reduce energy usage, increase factory throughput, and lower emissions, for example. In one embodiment, preform 100 has a thickness of about 125 microns and the maximum diffusion distance using two base metal layers 104 as opposed to a single base metal layer is reduced from about 62.5 microns to about 31.25 microns. In this example, bonding time may be reduced from about 25 minutes to about 6.25 minutes. In another embodiment, where preform 100 has three base metal layers 104, maximum diffusion distance may be about 20.83 microns and bonding time may be about 2.78 minutes.

FIG. 3 represents an application of a multilayer preform for fast transient liquid phase bonding according to an embodiment of the present invention. Shown is package structure 300, wherein the preform 100 may be disposed between a die 302 and a heat spreader structure 304, and also may be disposed between a heat spreader structure 304 and the heat sink structure 306. The preform 100 may comprise any of the embodiments of the present invention. In one embodiment, the die 302 may comprise a silicon die, and the package structure 300 may comprise a ceramic package and/or an organic package structure.

Although the foregoing description has specified certain steps and materials that may be used in the method of the present invention, those skilled in the art will appreciate that many modifications and substitutions may be made. Accordingly, it is intended that all such modifications, alterations, substitutions and additions be considered to fall within the spirit and scope of the invention as defined by the appended claims. In addition, it is appreciated that certain aspects of microelectronic devices are well known in the art. Therefore, it is appreciated that the Figures provided herein illustrate only portions of an exemplary microelectronic structure that pertains to the practice of the present invention. Thus the present invention is not limited to the structures described herein.

What is claimed is:

1. A method of forming a TIM comprising:
forming a plurality of first alloy layers;
forming a plurality of second alloy layers, wherein the second alloy has a melting temperature that is higher than the melting temperature of the first alloy; and
placing the first and second alloy layers together in an alternating sequence such that there is one more layer of the first alloy than of the second alloy and that the top and bottom layers of the formation are of the first alloy.

2. The method of claim 1 further comprising wherein the first alloy comprises at least one metal chosen from the group consisting of: tin, indium, bismuth, silver, zinc, and antimony.

3. The method of claim 1 further comprising wherein the second alloy comprises tin.

4. The method of claim 1 wherein placing the first and second alloy layers together comprises cold rolling alternate layers of the first alloy and the second alloy.

5. The method of claim 1 further comprising wherein the plurality of second alloy layers comprises three layers and wherein the plurality of first alloy layers comprises four layers.

6. The method of claim 1 further comprising laminating the multilayer formation.

7. The method of claim 6 further comprising placing the formation between an integrated circuit die and a heat spreader.

8. The method of claim 7 further comprising heating the formation to a temperature above the melting temperature of the first alloy and below the melting temperature of the second alloy.

9. A TIM structure comprising:
a plurality of first alloy layers; and
a plurality of second alloy layers, wherein the second alloy has a melting temperature that is higher than the melting temperature of the first alloy, and wherein the first and second alloy layers are arranged in an alternating sequence such that there is one more layer of the first alloy than of the second alloy and that the top and bottom layers of the sequence are of the first alloy.

10. The structure of claim 9 wherein the first alloy comprises tin-52% indium.

11. The structure of claim 9 wherein the first alloy comprises tin-57% bismuth.

12. The structure of claim 9 wherein the first alloy comprises tin-8.8% zinc.

13. The structure of claim 9 wherein the second alloy comprises pure tin.

14. The structure of claim 9 wherein the first and second alloys comprise tin and another metal and wherein the second alloy comprises a lower percentage of the another metal than the first alloy.

15. The structure of claim 9 further comprising wherein the TIM is disposed between a die and a heat sink structure.

16. A method comprising:
placing a multilayer preform between a die and a heat sink, wherein the multilayer perform comprises a three or more first alloy layers, and two or more second alloy layers, wherein the second alloy has a melting temperature that is higher than the melting temperature of the first alloy, and wherein the first and second alloy layers are arranged in an alternating pattern such that there is one more layer of the first alloy than of the second alloy and wherein the top and bottom layers of the preform are of the first alloy; and
heating the multilayer preform to a temperature above the melting point of the first alloy and below the melting point of the second alloy.

17. The method of claim 16 further comprising heating the multilayer preform until isothermal solidification is achieved.

18. The method of claim 16 further comprising wherein the first alloy comprises at least one metal chosen from the group consisting of: tin, indium, bismuth, silver, zinc, and antimony.

19. The method of claim 16 further comprising wherein the second alloy comprises tin.

20. The method of claim 16 further comprising wherein the second alloy layers comprises three layers and wherein the first alloy layers comprises four layers.
